(19) United States
(12) Patent Application Publication
(10) Pub. No.: US 2007/0036947 A1
(43) Pub. Date: Feb. 15, 2007

(54) Deflatable and self-inflating shock cushioning bubble

(76) Inventor: Morris L. Barwick, Greenville, TX (US)

Correspondence Address: MORRIS L. BARWICK, 5113 FM 2101, GREENVILLE, TX, 75402, US

(21) Appl. No.: 11/213,029

(22) Filed: Aug. 26, 2005

Related U.S. Application Data
(60) Provisional application No. 60/704,328, filed on Aug. 1, 2005.

(51) Int. Cl. B32B 3/12; B32B 1/00; B32B 3/00

(52) U.S. Cl. 428/178; 428/166

(57) ABSTRACT

I have invented a bubble membrane capable of deflation and self-inflation on a plurality of occasions without mechanical assistance. This bubble, usually of plastic membrane, will withstand impact forces as effectively as the hermetically sealed bubbles of prior art, but has the added advantage of minimal bulk in shipping, storage and handling and total immunity to going flat.

This application claims the benefit of Provisional Patent Application Ser. No. 60/704,328 filed Aug. 1, 2005, which includes the design and features cited herein.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND—FIELD OF INVENTION

This invention relates to a greatly improved version of plastic membrane bubbles presently used mostly in the impact shock protection of packages during shipment and which will drastically lower the overhead costs to the manufacturer and provide immunity against “flats”.

### BACKGROUND—DESCRIPTION OF THE PRIOR ART

Inflated bubbles have been used for years in the packaging industry. Typically, inflated bubbles are comprised of permanently sealed bubble membrane containing a fluid, usually air or other gas, and sometime affixed to a flexible panel.

U.S. Pat. No. 6,791,960 INFLATABLE, CUSHIONING, BUBBLE WRAP PRODUCT HAVING MULTIPLE, INTERCONNECTED, BUBBLE STRUCTURES to De Luca Jul. 13, 2004

All bubbles are externally inflated and interconnected to adjacent bubbles by an interconnecting passageway. No provision is made for total deflation or self re-inflation.

U.S. Pat. No. 5,518,802 CUSHIONING STRUCTURE to Colvin May 21, 1996

Assumes that the inflated composite of layers and cells will be inflated by external means. No provision is made for total deflation or self re-inflation.

One problem with conventionally sealed bubbles is the expense of shipping and storage. As a result of high shipping volume, in many cases the cost of shipment approaches one-third the cost of the original goods.

Another problem with prior art is the susceptibility to even the smallest leak rstn in a “flat”. The protected item becomes susceptible to damage. The bubble of my design contains an intentional leak and performance is not affected by a minor leak.

Another problem with prior art bubbles is that these panels are usually single usage. Environmental concerns are requiring more and more items to be recycled.

Another disadvantage with prior art bubbles is membrane deterioration when exposed to long-term stress, as in storage, resulting in a leak down.

Another disadvantage with prior art bubbles is expansion with increasing altitude and/or decreasing ambient pressure. This could change the original packaging clearances and forces.

Another disadvantage with prior art bubbles is the attempt to make bubbles inflatable on site. This has resulted in the necessity of an on-site inflator and is labor intensive.

Another disadvantage with prior art bubbles is the application of these bubbles as hailstone protection is not presently commercially available. This is probably due to poor handling and storage.

Another disadvantage with prior art bubbles is the poor thermal insulation characteristics due to the free circulation of the contained air when used as a blockage to heat transfer.

Another disadvantage with prior art bubbles is the inability to adjust the intensity of shock resistance offered by the bubbles by varying air exhaust blockage.

Another disadvantage with prior art bubbles is the poor sound blockage characteristics due to the free circulation of the contained air.

While these devices may be suitable for the particular purpose of which they address, they are not cost effective to the manufacturer or to the consumer and are wasteful of storage and handling.

In these respects, my deflatable and self-inflating bubble invention substantially departs from the concepts and designs of the prior art and in so doing provides an apparatus of increased cost reduced applications.

### SUMMARY

The field of packaging protection is largely comprised of hermetically sealed plastic bubbles. My Deflatable and Self-inflating bubble invention overcomes many disadvantages of prior art bubbles by greatly reducing volume when desired, and then return to full size. It is also the solution of many service problems.

### DRAWING FIGURES

In the drawings, closely related figures have the same number but different alphabetic suffixes.

FIG. 1 and FIG. 2 show the internal construction of the primary embodiment with orifice.

FIG. 3 is the primary embodiment of FIG. 2 in the compressed state with optional sealing membrane attached at one bubble orifice in order to maintain compressed state without external force.

FIG. 4 shows an optional hole in the panel membrane, between bubbles, to accept indexing pin 90 for positional reference for dispensing and cutting.

FIG. 5 is a bubble construction of prior art but containing an expander 20C and said orifice 30.

FIG. 6 shows the internal usage of a spring expander.

FIG. 7 shows the internal usage of a thin shape expander.

FIG. 8 and FIG. 9 propose a method of manufacture.

FIG. 10 is the bubble of FIG. 2 in contact with an item to be shielded from impact and demonstrates highly restrictive fluid exhaust path.

FIG. 11 and shows the higher deflation rate by the use of a “venting” pad.

FIG. 12 shows a panel of rectangular bubbles with thin resilient shapes ready to be inserted therein with optional membrane over bubble extremities.

FIG. 13 shows a unique padded box, employing my invention, in the flat for a specific customer. This box would ship flat and possibly lend itself to automatic packaging of customer's item.

### DESCRIPTION—MAIN EMBODIMENT

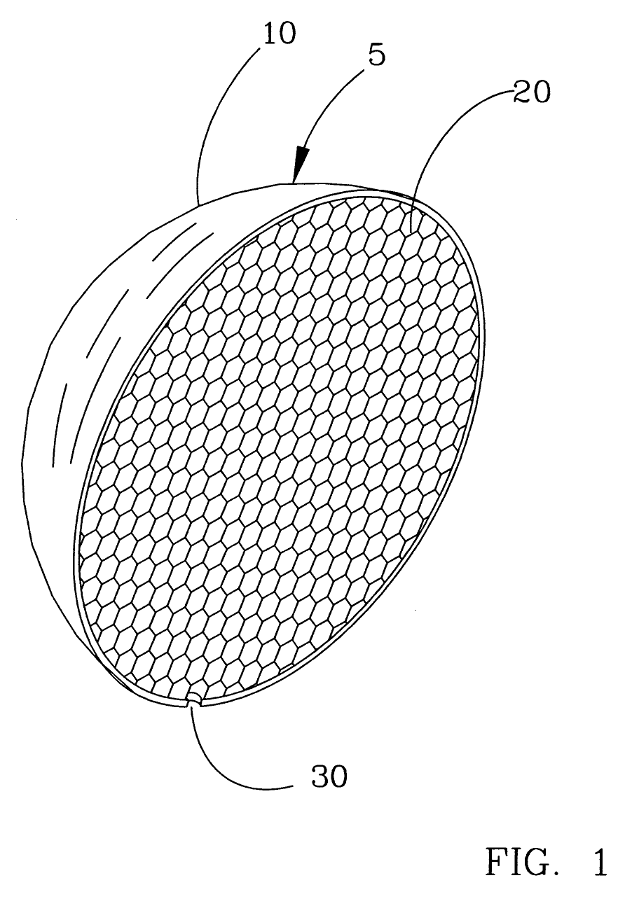

FIG. 1 is a section view showing the basic concept of a closed bubble assembly 5 consisting of membrane 10 and containing an expander 20 which always seeks to occupy all of the volume available within the bubble membrane. Located in the membrane wall is a fluid communication orifice hole 30 which will allow the contained fluid, usually air, to enter and exit the bubble upon the existence of a pressure differential.

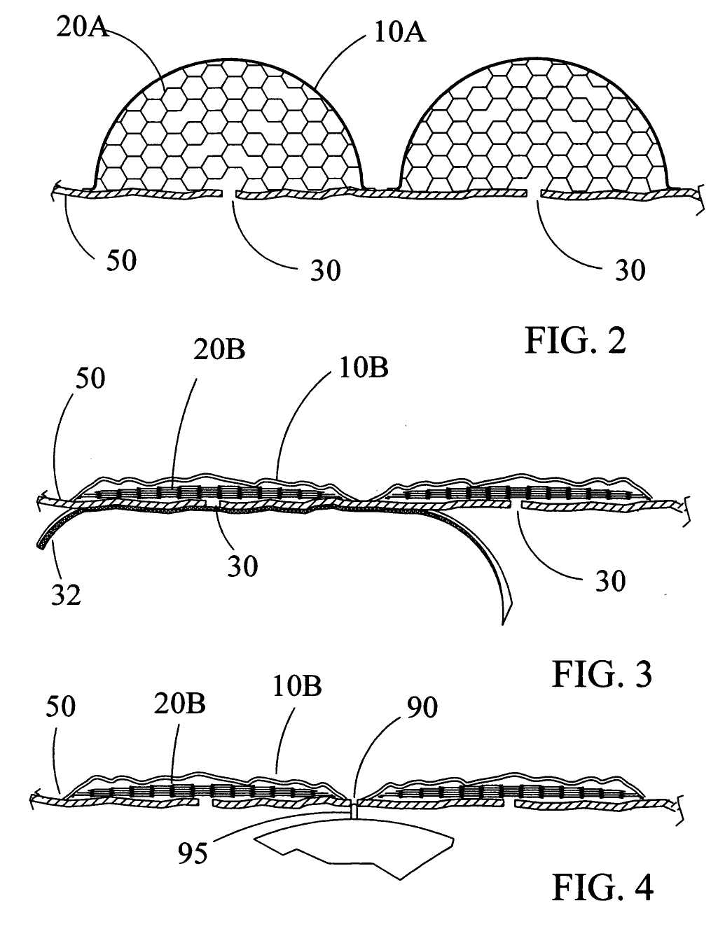

FIG. 2 is a section view of the bubble assembly 5 of FIG. 1 with membrane 10 configured as a hemisphere 10A and the edge of the membrane 10A is peripherally bonded to, or integral with, a flexible panel 50 and engulfing the expander 20A inside. The orifice 30 through the bubble membrane of FIG. 1 may relocate to the flexible panel 50, if desired. Expander 20A is expander 20 but shaped to fill newly shaped bubble 10A.

FIG. 3 is a section view of the bubble assembly of FIG. 2, which has been exposed to a small but constant flattening force. All fluid contained within the bubble 10A of FIG. 2 has been leisurely exhausted through orifice 30 resulting in deflated membrane 10B. The contained expander 20A is forcibly compressed and flattened also, shown as 20B. Optional sealing tape or membrane 32 is shown blocking the entrance of air through said orifice 30 to one bubble and thereby constraining the bubble in the flattened condition. The membrane 32 may be reattached after the bubble is in the maximum unconstrained and inflated state, thereby rendering its performance similar to a prior art sealed bubble.

FIG. 1 thru FIG. 4 expander 20 is assumed to be flexible open cell foam.

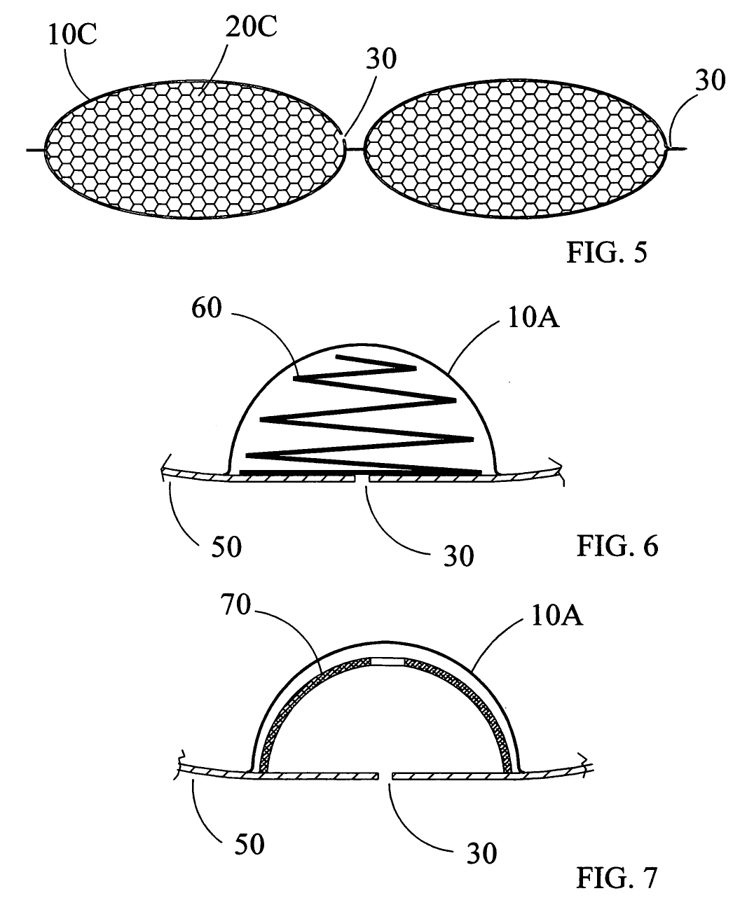

FIG. 5 thru FIG. 13 will be discussed in “discussion of alternate embodiments and applications” section.

### Discussion of Primary Embodiment

The general purpose of this invention is to provide a new deflatable and self-inflating bubble for impact protection with many of the protection advantages of prior art but with many novel features in a new deflatable and self-inflating bubble which is not anticipated, rendered obvious, suggested, or even implied by any of the prior art of packaging bubbles, either alone or in any other combination.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

In this discussion, a bubble is defined as any membrane or web material engulfing a volume and being temporarily hermetically sealed. An expander is any device or membrane characteristic, which will urge the vented bubble to seek maximum internal volume.

A primary object of the present invention is to provide a bubble membrane capable of resisting impact forces and preventing them from being transferred as well as convenience in handling, shipping, storage and usage.

A secondary object of the present invention is to provide debatable and self-inflating bubble for packaging, which can support the weight of a packed object with a cushion type support and yet offer high resistance to impact forces.

Another object is to provide a deflatable and self-inflating bubble eliminating susceptibility to deflated bubbles or “flats”.

Another object is to provide a deflatable and self-inflating bubble for protective packaging of fragile objects where it will expand unaided to fill voids between the packed object and the volume confines of the shipping container.

Another object is to provide pre-positioned bubbles attached to the inside surfaces of a packing box in accordance with customer's unique application. These boxes can be shipped in the flat in little more volume than the boxes alone.

Another object is to provide deflatable and self-inflating bubbles for providing impact resistance from hailstones to susceptible surfaces but convenient in handling and storage.

Another object is to provide deflatable and self-inflating bubbles for hailstone protection that can be applied over the protected surface and left for extended periods of time without deterioration.

Another object is to provide a deflatable and self-inflating bubble for providing thermal insulation between confining structures. This feature is provided by the use of a Sponge type foam expander internal to the bubble. This provides resistance to convection fluid currents within the bubble.

Another object is to provide a deflatable and self-inflating bubble for providing sound insulation between confining structures. This feature is provided by the use of a foam expander internal to the bubble. This provides resistance to air currents within the bubble, thereby reducing sound passage.

Another object is to be incorporated into a garment capable of protecting the wearer from cold and or impacts without being restrictive in bulk.

Another object is to provide a displacer of empty air within a refrigerated container, thereby lessening the loss of pre-cooled air when opened.

Other objects and advantages of the present invention will become obvious to the reader and it is intended that these objects and advantages be within the scope of the present invention.

To attain this, the present invention generally comprises a spherical, hemispherical, pillow or cube shaped, self-inflating bubble of flexible membrane construction with the ability to be deflated as desired by the application of minor continuous force.

The basic bubble is a membrane forming a complete hermetically sealed closed volume engulfing an expander, containing a fluid and containing a communication orifice, which places the internal fluid in constant communication with external fluid, usually air.

When impacted by a short duration shock force, the fluid contained therein is unable to exhaust through said orifice in any significant amount in the short time duration and thereby imparts bubble characteristics of prior art of being totally sealed.

Inherent in this bubble is the desire to always occupy maximum volume by virtue of said expander contained within or by membrane memory characteristics.

The expander contained within is a three-dimensional thin filament, foam, sponge, spring or shape capable of being highly compressed but when released, it desires to expand, with slight force, to the it's original volume and constrained only by the volume of the bubble wherein it is contained. Subsequent applications may prefer to make this expander able to support anticipated weight at the sacrifice of a portion of the compressibility.

A flexible or rigid panel, to which multiple bubbles may be attached or integral with, in order to maintain positional order among a multiplicity of bubbles, could be incorporated as desired.

A web or membrane may be attached to the outer extremities of the bubbles in order to share impacts occurring between bubbles by imparting tensile forces in said membrane. Web must be freely vented to surrounding atmosphere in order not to increase minimum shipping thickness.

A coating may be applied to, or contained within the materials of construction, which will provide environmental protection for parts of the bubble and/or panel.

Bubbles can be kept in the compressed state by the application of a sealing membrane over the fluid passage orifice while compressed. When the sealing membrane is removed, the bubbles expand. If desired, the sealing membrane can be replaced while the bubble is in the expanded state and thereby creating a prior art sealed bubble containing the expander.

To the accomplishment of the above and related objects, this invention may be embodied in the form illustrated in the accompanying drawings, attention being called to the fact, however, that the drawings are illustrative only, and that changes may be made in the specific construction illustrated.

### DESCRIPTION—ADDITIONAL EMBODIMENTS

FIG. 5 shows a pillow shaped bubble with said orifice 30 in the membrane wall or in the connecting membrane.

FIG. 6 is said bubble 10A containing a spring expander 60 in place of foam 20.

FIG. 7 is a resilient, thin walled shaped expander 70 replacing the foam 20A expander of FIG. 2.

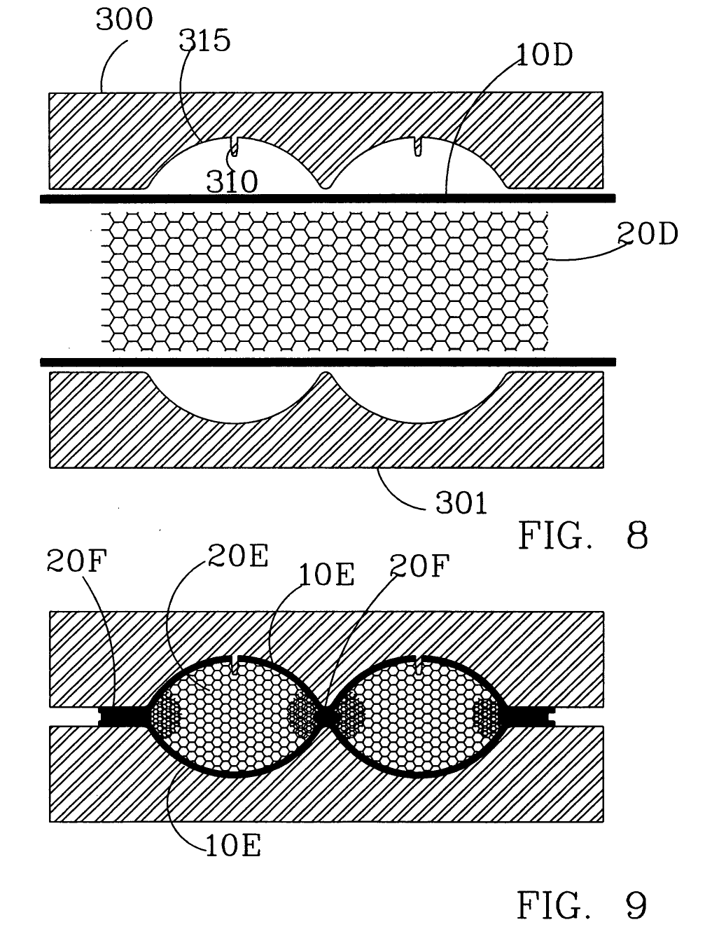

FIG. 8 depicts a method of manufacturing where platens 300 and 301 are preparing to compress expander foam 20D with bubble membrane 10D and thereby forming bubble.

FIG. 9 depicts platens 300 and 301 compressing expander foam and thereby forming bubble into recesses and fusing membrane 20F and expander 20E circumferentially around bubble possibly to foam 20E. Protrusion 310 penetrates membrane 10E and forms the orifice in the bubble membrane. Said orifice may be added before or after bubble formation.

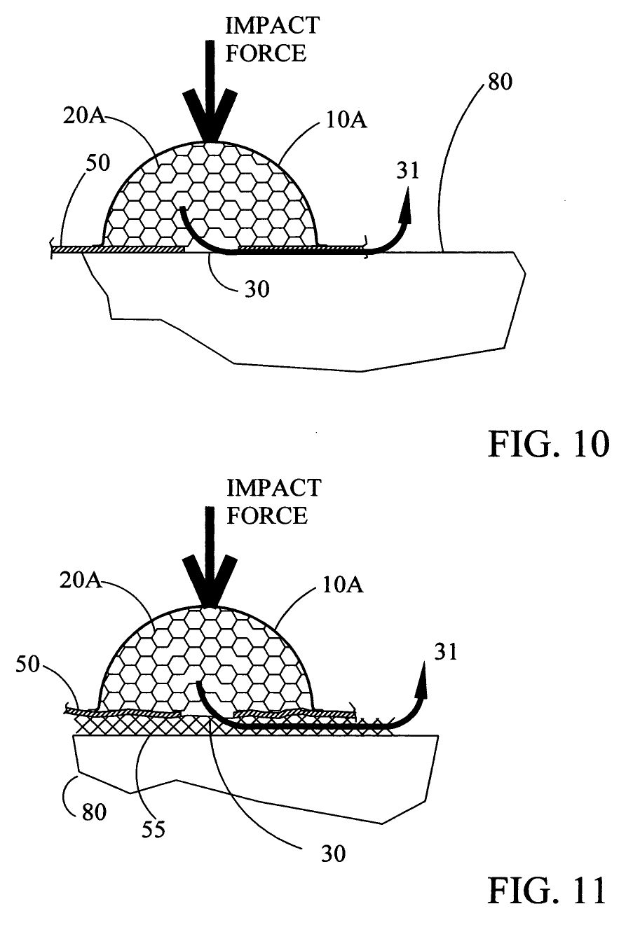

FIG. 10 a cross section of the bubble of FIG. 2 showing the airflow 31 through orifice 30 out of the bubble along faying surfaces when an impact force presses the orifice 30 against the protected item 80.

FIG. 11 application of a mostly open weave material 55 which will allow maximum airflow 31 radially from 30. This could be replaced by incorporating a serrated annulus bung around orifice with radial passageways.

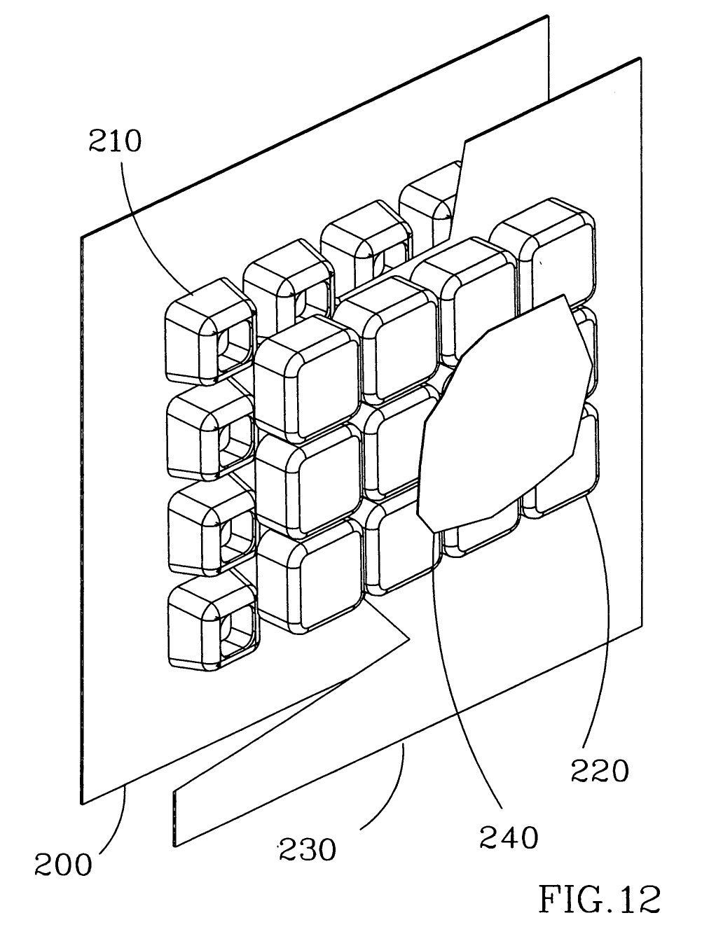

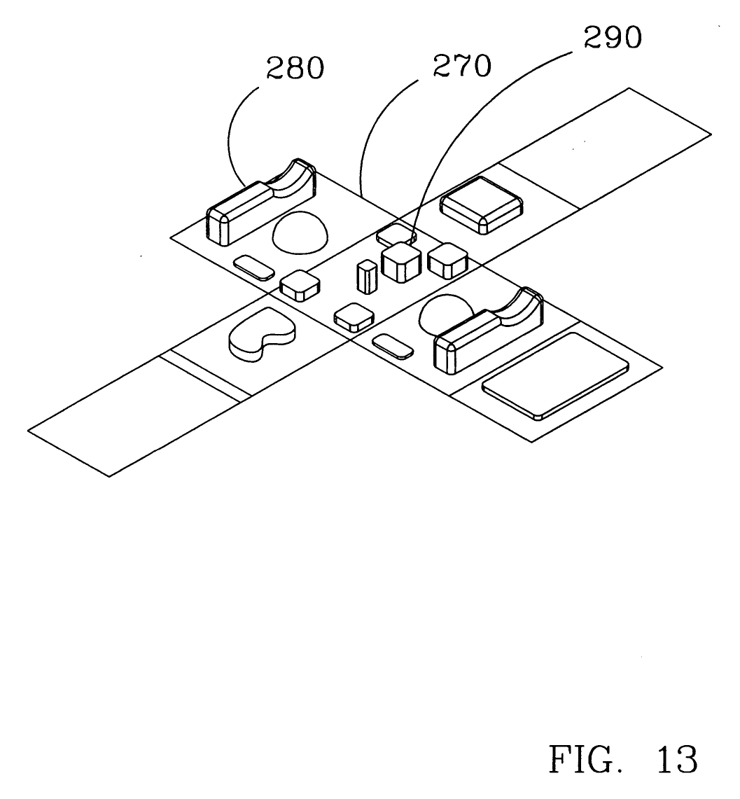

FIG. 12 an array of parallelpiped bubbles 220 as part of a panel membrane 230 and ready to accept thin wall resilient expanders 210. After insertion of 210 into the bubbles 220, the flexible membrane panel 200 is bonded to 230 forming a hermetic seal within each bubble. The communication orifice may exist in panel 200 before bonding or added later or may be contained in each bubble. The expanders are not of necessity a thin walled resilient shape as shown but can be of any type desired. Optional load sharing membrane 240 is depicted attached to bubble extremities.

FIG. 13 is a custom designed shipping container containing pre-positioned and uniquely shaped collapsible and self-inflating bubbles. This approach to package design has been impractical in prior art due to shipping volume limitations, but volume constraints are no longer a factor when using my invention of collapsible bubbles.

### Advantages

From the description noted above, it is obvious that impact protection is not sacrificed by virtue of being able to collapse the bubbles. Experimentation has shown a collapse ratio of 11:1 is easily attained. This means 1 truck will replace 11 trucks in shipment, 1 warehouse will replace 11 warehouses in storage etc.

### Operation

The principle involved in using a non-sealed bubble is that when struck by a quick blow, the time of impact is of such short duration that loss of entrapped fluid to the surrounding atmosphere, through orifice 30 is minimal and shock performance is similar to that of a sealed bubble.

During manufacture, the internal expander 20 is placed within the bubble 10 or 10A and the communication orifice 30 is incorporated into the sealing membrane. The bubbles or panel of bubbles are mechanically compressed to minimum size and packaged as a roll or in a shipping carton.

Optionally the bubbles may be maintained in the compressed state by the closure of the orifice by a sealing membrane.

Upon delivery to the purchaser, the compressed bubbles can be placed in storage until needed at the site whereupon the sealing membrane is removed and the bubble is allowed to expand again to its normal volume. Storage requirements are much less than prior art.

If ultimately a sealed bubble configuration, similar to prior art, is desired for long-term load support, the sealing tape membrane is replaced over the orifice after expansion.

If desired, the deflated bubbles can be quickly placed into the packaging container and allowed to inflate in place.

It is noted that individual bubbles may be supplied loose packaged and inserted into the shipping package like “peanuts” to protect fragile items.

It now becomes feasible to provide packing boxes in the flat with custom sized and shaped shock-protecting bubbles bonded in place as the need is defined as shown in FIG. 13. These box flats can now be shipped consuming probably not more than twice the volume the bare box flats would consume.

It is now convenient to apply panels of bubbles over an automobile or aircraft for hail protection, as they will require minimal storage space when removed.

### CONCLUSION, RAMIFICATION AND SCOPE

It can be seen that many new applications, in addition to those applications of prior art, are now available to this form of bubble since bulk is no longer a limiting factor.

When used to protect an aircraft wing from hail damage, the aerodynamic characteristics of the wing are masked from high winds and negative lift may be created.

When used in clothing or sports uniforms, warmth and/or impact protection does not come with unyielding bulk.

The bubbles may be stuffed into a freezer, or other refrigerated volume, to occupy unused space and reduce lost cold air when opened for access.

I claim:

1. A deflatable and self-inflating shock cushioning bubble of thin membrane construction capable of impact protection by limiting sudden forcible volume decrease which would require an excessive amount of contained fluid to pass through an orifice where it is in bi-directional communication with environmental fluid external to the bubble and comprised of:

2. the bubble of claim 1 containing an internal expander capable of urging said bubble to return to its prior to deflation volume and thereby replacing the previously exhausted fluid with ambient fluid by flow through said orifice in the containment barrier or

3. the bubble of claim 1 consisting of a memory material membrane desirous of returning to its shape prior to deflation and thereby replacing previously exhausted fluid with ambient fluid through said orifice in the containment barrier without the aid of an internal expander or external mechanical means and

4. the bubble of claim 1 capable of being deflated by minimal force in a leisurely manner and allowed to self-inflate without the assistance of external inflators on a plurality of occasions for expeditious shipping and storage and

5. Shipping containers shipped in the flat containing positionally attached deflatable and self-inflating bubbles simplifying shipped article packing and yet provide economical shipping and storage.

6. The inclusion of holes external to said bubbles in the said panel membrane to provide position and propulsion of said membrane.
